(19) United States
(12) Patent Application Publication
(10) Pub. No.: US 2011/0244703 A1
(43) Pub. Date: Oct. 6, 2011

(54) Cold Cathode Fluorescent Lamp Connector

(76) Inventors: Hung-Chi Wang, Taipei (TW); Chin-Te Chiu, Taipei (TW); Ning-Lang Cheng, Taipei (TW); Mei-Chuan Yang, Taipei (TW)

(21) Appl. No.: 12/752,093

(22) Filed: Mar. 31, 2010

(51) Int. Cl. H01R 33/08

(52) U.S. Cl. 439/235

(57) ABSTRACT

A cold cathode fluorescent lamp connector includes a holding base and a plurality of terminals. The holding base has a base board and a plurality of terminal housings which are integratedly molded with the base board as a single piece, each of the terminal housings is perpendicularly interweaved in the base board, two opposite ends of the base board respectively define a first locking portion and a second locking portion matchable with the first locking portion for making the first locking portion of one cold cathode fluorescent lamp connector can be engaged with the second locking portion of another cold cathode fluorescent lamp connector so as to series-connect a plurality of the cold cathode fluorescent lamp connectors together. The terminals are respectively received in the terminal housings of the holding base.

### BACKGROUND OF THE INVENTION

1. Field of the Invention

The present invention generally relates to a lamp connector, and more particularly to a cold cathode fluorescent lamp connector.

2. The Related Art

A conventional cold cathode fluorescent lamp connector generally includes a base board, a plurality of terminal housings and terminals respectively received in the corresponding terminal housings. The base board defines a plurality of fastening grooves spaced at regular intervals. The terminal housings with the respective terminals therein are fastened in the corresponding fastening grooves respectively. However, the base board and the terminal housings mounted to the base board are separately designed, so different molds need to be designed, when producing the cold cathode fluorescent lamp connector. As a result, the cold cathode fluorescent lamp connector has a complicated manufacture and assembly procedure, and more working time is wasted. Furthermore, the design of the base board is single that causes the length of the cold cathode fluorescent lamp connector unchanged according to different situations, and the applicability of the cold cathode fluorescent lamp connector is weakened.

### SUMMARY OF THE INVENTION

An object of the present invention is to provide a cold cathode fluorescent lamp connector. The cold cathode fluorescent lamp connector includes a holding base and a plurality of terminals. The holding base has a base board and a plurality of terminal housings which are integratedly molded with the base board as a single piece, each of the terminal housings is perpendicularly interweaved in the base board, two opposite ends of the base board respectively define a first locking portion and a second locking portion matchable with the first locking portion for making the first locking portion of one cold cathode fluorescent lamp connector can be engaged with the second locking portion of another cold cathode fluorescent lamp connector so as to series-connect a plurality of the cold cathode fluorescent lamp connectors together. The terminals are respectively received in the terminal housings of the holding base.

As described above, the cold cathode fluorescent lamp connectors of the present invention not only can be series-connected firmly, but also can be disassembled easily so as to form different lengths of cold cathode fluorescent lamp connector assembly according to the design of the first locking portion and the corresponding second locking portion. Furthermore, the terminal housing is integratedly molded with the base board as a single piece, so that decreases the molding cost, simplifies the assembly procedure and further saves working time.

### BRIEF DESCRIPTION OF THE DRAWINGS

The present invention will be apparent to those skilled in the art by reading the following description, with reference to the attached drawings, in which:

FIG. 1 is a perspective view of a cold cathode fluorescent lamp connector in accordance with an embodiment of the present invention;

FIG. 2 is an exploded perspective view of the cold cathode fluorescent lamp connector of FIG. 1;

FIG. 3 is a sectional view of a holding base of the cold cathode fluorescent lamp connector of FIG. 1;

FIG. 4 is a perspective view of a terminal of the cold cathode fluorescent lamp connector of FIG. 1;

FIG. 5 is another perspective view of the terminal of the cold cathode fluorescent lamp connector of FIG. 1;

FIG. 6 and FIG. 7 are respectively perspective views of a first locking portion and a second locking portion of a holding base of a cold cathode fluorescent lamp connector according to another two embodiments of the present invention; and

FIG. 8 is a perspective view of a cold cathode fluorescent lamp connector assembly formed by means of a plurality of the cold cathode fluorescent lamp connectors of FIG. 1 series-connected.

### DETAILED DESCRIPTION OF THE PREFERRED EMBODIMENT

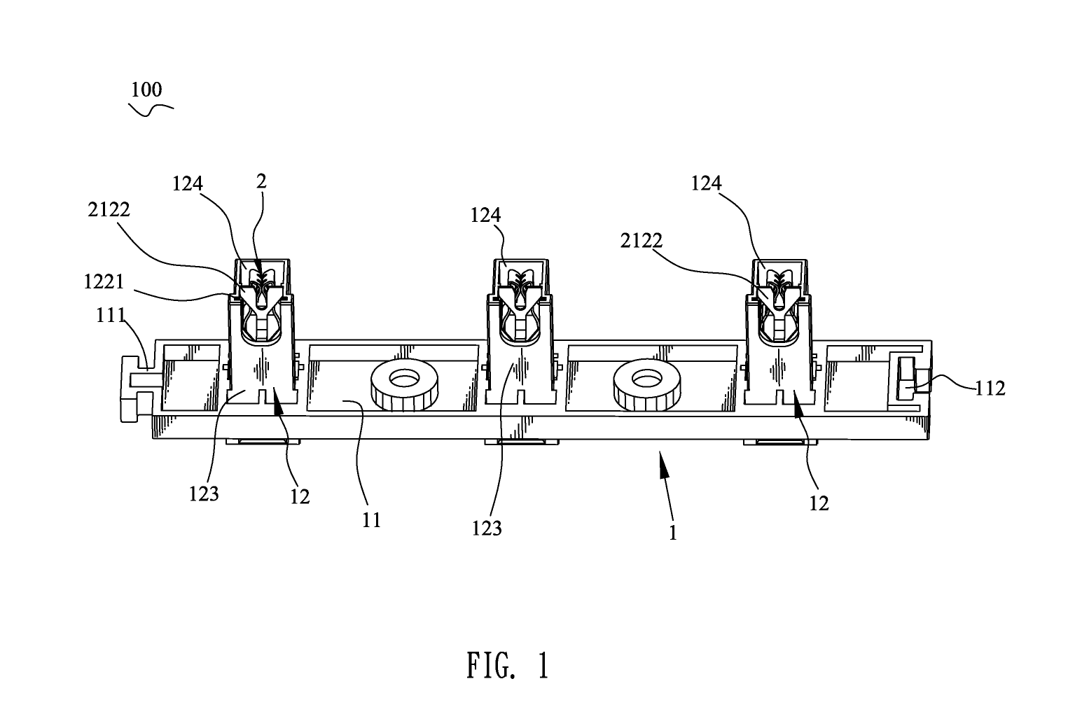

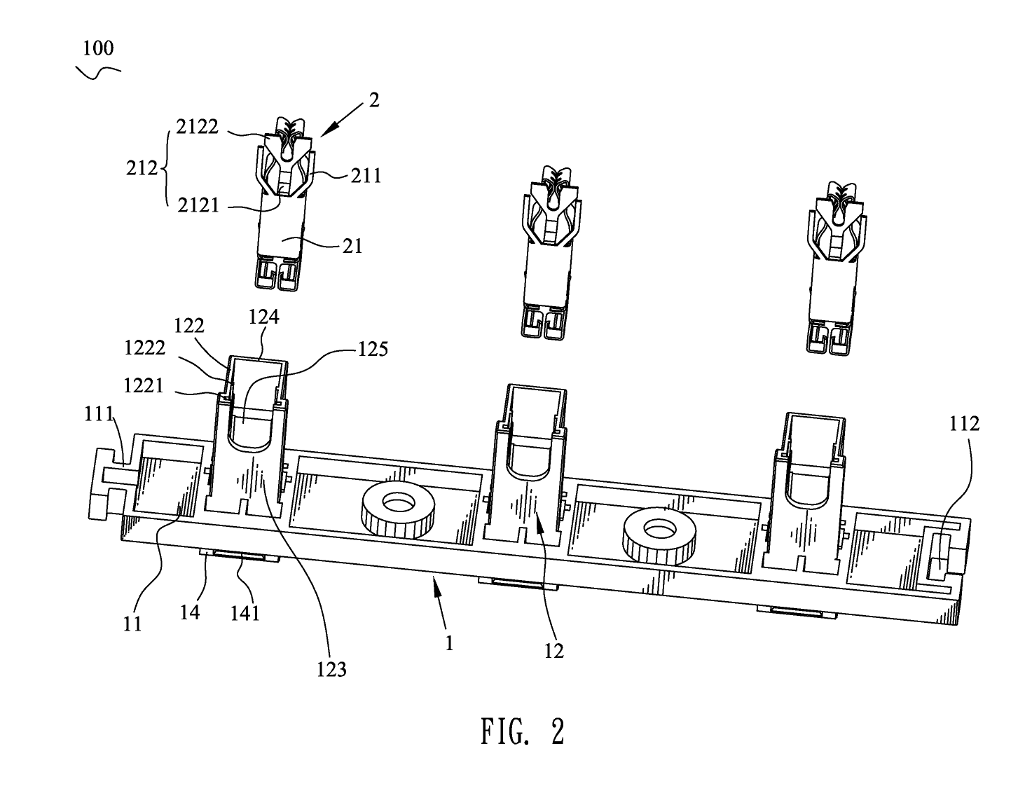

With reference to FIG. 1 and FIG. 2, a cold cathode fluorescent lamp connector 100 in accordance with the present invention includes a holding base 1 and a plurality of terminals 2 assembled in the holding base 1 respectively.

Referring to FIG. 2, the holding base 1 is molded by the insulating material and has a long rectangular base board 11. Two opposite ends of the base board 11 respectively define a first locking portion and a second locking portion matchable with each other in shape, so the first locking portion of one base board 11 can be engaged with the second locking portion of another base board 11 to further series-connect a plurality of base board 11 together. In this embodiment, a middle of one end of the base board 11 perpendicularly extends outward to form a T-shaped fastening portion 111 acted as the first locking portion, and a middle of the other end of the base board 11 is concaved inward to form a T-shaped fastening groove 112 acted as the second locking portion. The holding base 1 further has a plurality of terminal housings 12 which are integratedly molded with the base board 11 as a single piece and arranged at regular intervals along a longwise direction of the base board 11.

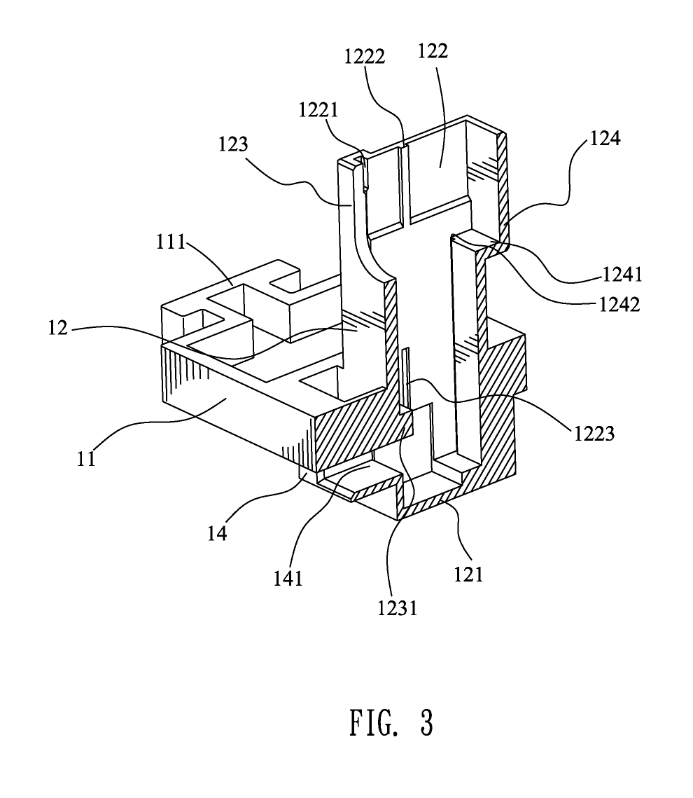

Referring to FIG. 2 and FIG. 3, each of the terminal housings 12 looks like being perpendicularly interweaved in the base board 11 and shows a hollow rectangular box-shape with a bottom wall 121, two opposite side walls 122, a front wall 123 and a rear wall 124 which are connected together to define a rectangular accommodating chamber 125 thereamong. Two insides of the two side walls 122 oppositely concaved outward to form two locating grooves 1221 adjacent to the front wall 123 at a top thereof, are face-to-face protruded inward to form two blocking ribs 1222 at a substantial middle of the top thereof, and further oppositely concaved outward to form two buckling grooves 1223 at a substantial middle of a lower portion thereof, wherein the locating grooves 1221, the blocking ribs 1222 and the buckling grooves 1223 are vertically extended. A lower portion of an inside of the rear wall 124 protrudes inward to form a propping step 1241, two opposite sides of a front of the propping step 1241 concave inward to form two locking grooves 1242 extending vertically and adjacent to the corresponding side walls 122. A bottom of the front wall 123 protrudes forward to form a protrusion 14 connected under the base board 11, and there is a window 141 penetrating through the protrusion 14 from front to rear to communicate with the accommodating chamber 125 and adjacent to the base board 11. A lower portion of an inside of the front wall 123 protrudes rearward to form a blocking portion 1231 adjacent to a top of the window 141.

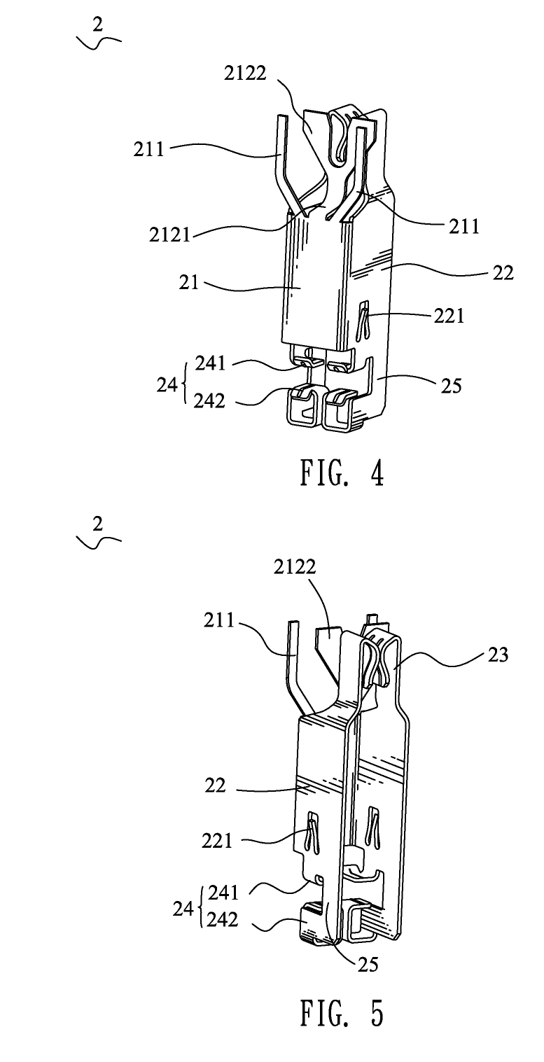

Referring to FIG. 2, FIG. 4 and FIG. 5, each of the terminals 2 is stamped from a sheet metal and has a rectangular base plate 21 disposed vertically. Two ends of a top of the base plate 21 obliquely extend outward and then extend upward to form two locating strips 211 spaced from each other and located at the same vertical plane with the base plate 21. A substantial Y-shaped rack 212 from a front view is formed between the two locating strips 211, and includes a locating portion 2121 which extends rearward from a middle of the top of the base plate 21 and then is bent upward and two blocking pieces 2122 which are oppositely extended outward from a top of the locating portion 2121. Two opposite side edges of the base plate 21 extend rearward to form two connecting plates 22 of which each defines a buckling arm 221 having a bottom end connected to the corresponding connecting plate 22 and a top end freely inclined outward. Rears of tops of the two connecting plates 22 extend upward and then are face-to-face bent to further extend downward to form two contact portions 23 approaching to each other. Fronts of bottoms of the connecting plates 22 slightly extend downward and then are face-to-face bent to form two first connecting pieces 241 spaced from each other. There are two second connecting pieces 242 further provided under and spaced from the corresponding first connecting pieces 241 respectively. The second connecting pieces 242 are respectively connected with a rear of the bottom of the respective connecting plate 22 through an L-shaped connecting arm 25, and are formed by means of extending face-to-face and then extending upward to further have two free ends oppositely extended. The first connecting pieces 241 and the second connecting pieces 242 together define a connecting portion 24.

Referring to FIG. 1, when the cold cathode fluorescent lamp connector 100 is assembled, the terminal 2 is received in the corresponding accommodating chamber 125 of the terminal housing 12. Wherein the locating strips 211 are received in the locating grooves 1221 respectively, the rack 212 stretches into the accommodating chamber 125 to support a cold cathode fluorescent lamp (not shown) and the blocking pieces 2122 are restrained by the corresponding blocking ribs 1222. A bottom edge of the base plate 21 abuts on the blocking portion 1231. Rear edges of the connecting plates 22 are fastened in the corresponding locking grooves 1242. The buckling arms 221 are buckled in the buckling grooves 1223 respectively. The contact portions 23 are used to connect with the cold cathode fluorescent lamp (not shown). The connecting portion 24 is located under the blocking portion 1231 and exposed through the window 141. The connecting portion 24 is used to connect with a printed circuit board (not shown).

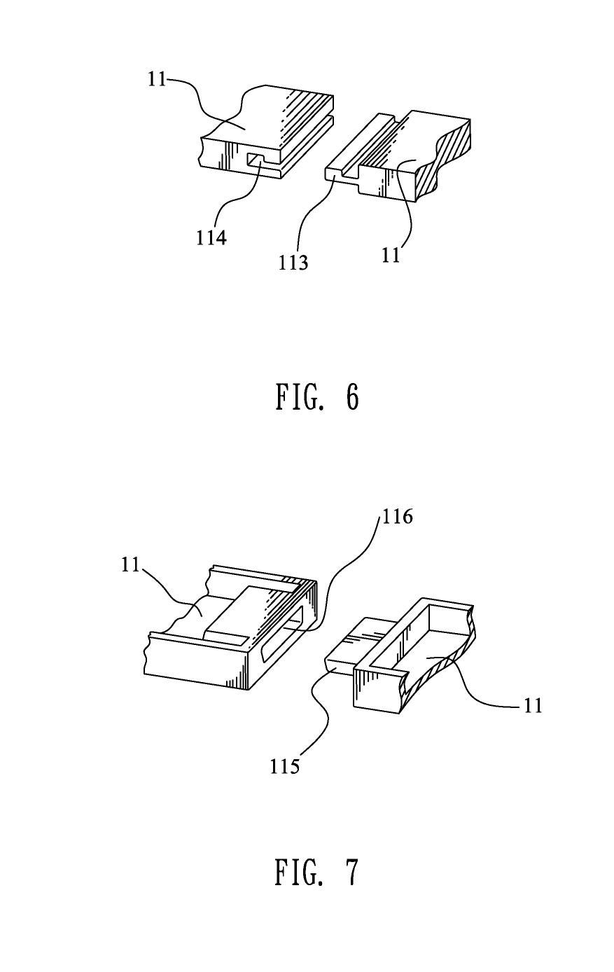

FIG. 6 and FIG. 7 are perspective views of a first locking portion and a second locking portion of a holding base 1 according to another two embodiments of the present invention. Referring to FIG. 6, a middle of one end of the base board 11 is concaved inward to form an L-shaped clipping groove 114 of which two opposite ends penetrate through two opposite sides of the base board 11 respectively, and a middle of the other end of the base board 11 protrudes outward to form an L-shaped clipping portion 113 matchable with the clipping groove 114. The clipping groove 114 and the clipping portion 113 are respectively regarded as the first locking portion and the second locking portion. Referring to FIG. 7, a middle of one end of the base board 11 is concaved inward to form a trapezoid inserting groove 116, and a middle of the other end of the base board 11 protrudes outward to form a trapezoid inserting portion 115 matchable with the inserting groove 116. The inserting groove 116 and the inserting portion 115 are respectively regarded as the first locking portion and the second locking portion.

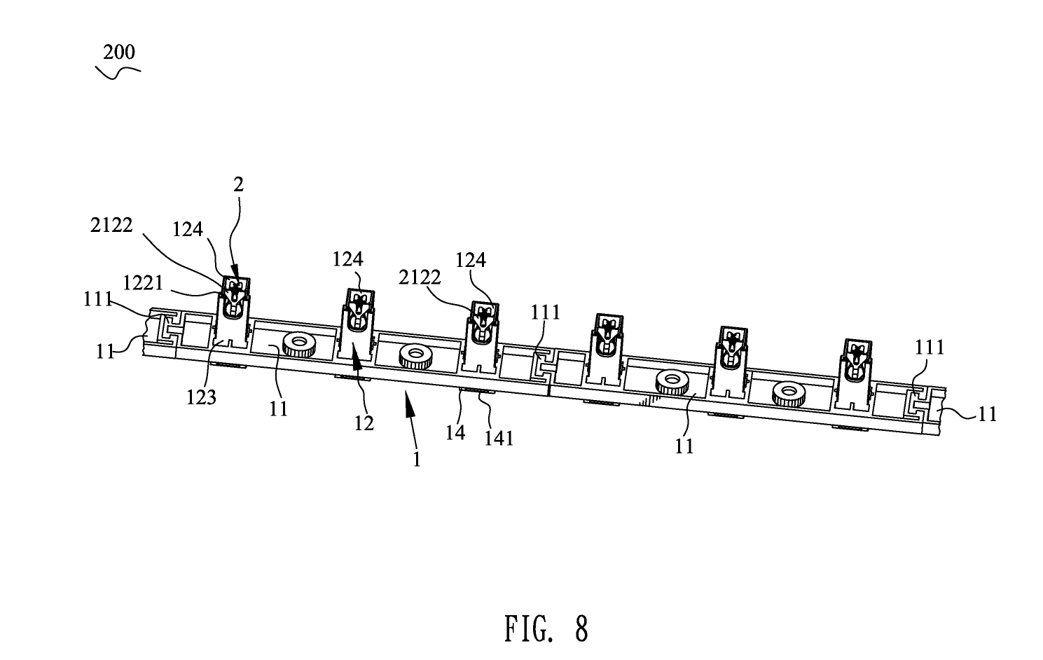

Referring to FIG. 8, a plurality of the cold cathode fluorescent lamp connectors 100 can be series-connected to form a cold cathode fluorescent lamp connector assembly 200 by means of the first locking portion and the corresponding second locking portion engaged with each other.

As described above, the cold cathode fluorescent lamp connectors 100 of the present invention not only can be series-connected firmly, but also can be disassembled easily so as to form different lengths of cold cathode fluorescent lamp connector assembly 200 according to the design of the first locking portion and the corresponding second locking portion. Furthermore, the terminal housing 12 is integratedly molded with the base board 11 as a single piece, so that decreases the molding cost, simplifies the assembly procedure and further saves working time.

What is claimed is:

1. A cold cathode fluorescent lamp connector, comprising:
a holding base having a base board and a plurality of terminal housings which are integratedly molded with the base board as a single piece, each of the terminal housings being perpendicularly interweaved in the base board, two opposite ends of the base board respectively defining a first locking portion and a second locking portion matchable with the first locking portion for making the first locking portion of one cold cathode fluorescent lamp connector can be engaged with the second locking portion of another cold cathode fluorescent lamp connector so as to series-connect a plurality of the cold cathode fluorescent lamp connectors together; and
a plurality of terminals respectively received in the terminal housings of the holding base.

2. The cold cathode fluorescent lamp connector as claimed in claim 1, wherein a middle of one end of the base board perpendicularly extends outward to form a T-shaped fastening portion acted as the first locking portion, and a middle of the other end of the base board is concaved inward to form a T-shaped fastening groove acted as the second locking portion and mated with the fastening portion.

3. The cold cathode fluorescent lamp connector as claimed in claim 1, wherein a middle of one end of the base board is concaved inward to form an L-shaped clipping groove of which two opposite ends penetrate through two opposite sides of the base board respectively, and a middle of the other end of the base board protrudes outward to form an L-shaped clipping portion mated with the clipping groove, the clipping groove and the clipping portion are respectively regarded as the first locking portion and the second locking portion.

4. The cold cathode fluorescent lamp connector as claimed in claim 1, wherein a middle of one end of the base board are concaved inward to form a trapezoid inserting groove, and a middle of the other end of the base board protrudes outward to form a trapezoid inserting portion mated with the inserting groove, the inserting groove and the inserting portion are respectively regarded as the first locking portion and the second locking portion.
